(19) United States
(12) Patent Application Publication
(10) Pub. No.: US 2025/0349875 A1
(43) Pub. Date: Nov. 13, 2025

(54) BATTERY MANUFACTURING APPARATUS AND CONTROLLING METHOD OF THE SAME

(71) Applicant: SK On Co., Ltd., Seoul (KR)

(72) Inventors: Eun Soo CHO, Daejeon (KR); Jun Hui JEONG, Daejeon (KR); Sung Yeop KIM, Daejeon (KR)

(21) Appl. No.: 19/206,053

(22) Filed: May 13, 2025

(30) Foreign Application Priority Data
May 13, 2024 (KR) 10-2024-0062595

(51) Int. Cl. H01M 10/04

(52) U.S. Cl. CPC H01M 10/0404; H01M 10/0481

(57) ABSTRACT

The present disclosure relates to a battery manufacturing apparatus and a controlling method thereof. The battery manufacturing apparatus includes a plurality of cell processors arranged in a first direction, the plurality of cell processors each including a heating unit to heat a battery cell, and a movement adjuster adjusting a distance between the plurality of cell processors by moving the plurality of cell processors in the first direction, wherein one cell processor among the plurality of cell processors maintains a distance between the one cell processor and another cell processor adjacent to the one cell processor at a predetermined target distance by the movement adjuster, and heats the battery cell mounted on the one cell processor together with the another cell processor adjacent to the one cell processor.

### CROSS-REFERENCE TO RELATED PATENT APPLICATION

This application claims priority under 35 U.S.C. § 119 (a) to Korean patent application number 10-2024-0062595 filed on May 13, 2024, in the Korean Intellectual Property Office, the disclosure of which is incorporated by reference herein in its entirety.

### BACKGROUND OF THE INVENTION

### 1. Field

The disclosure relates to a battery manufacturing apparatus used in manufacturing a battery cell and a controlling method thereof, and more particularly, to a battery manufacturing apparatus for improving the efficiency of a battery cell manufacturing process or a formation process, and a method of controlling the battery manufacturing apparatus.

### 2. Description of the Related Art

A battery cell manufacturing process involves assembling a battery cell, heating the battery cell, and pre-charging the battery cell. In particular, the process of heating the battery cell may improve the wettability of an electrolyte in the battery cell and facilitate pre-charging.

However, typically, in the case of a prismatic battery cell, heating is performed by using a bottom surface of the prismatic battery cell, and thus, it takes a relatively long time to heat the prismatic battery cell. In addition, since only the bottom surface of the prismatic battery cell is heated, the prismatic battery cell may not be uniformly heated. Also, a case of the prismatic battery cell may be deformed due to gas during heating.

### SUMMARY

An object of the present disclosure is to increase a heating area of a battery cell and uniformly heat the increased heating area.

Another object of the present disclosure is to reduce the time required to heat the battery cell.

Another object of the present disclosure is to reduce the deformation of a case of the battery cell when the battery cell is heated.

Another object of the present disclosure is to improve the impregnation of an electrolyte and facilitate pre-charging.

Another object of the present disclosure is to improve the efficiency of manufacturing processes of the battery cell.

Meanwhile, the present disclosure may be widely applied in the fields of electric vehicles, battery charging stations, energy storage systems (ESS), and other green technologies such as photovoltaics and wind power using batteries. In addition, the present disclosure may be used in eco-friendly mobility, including electric vehicles and hybrid vehicles, to prevent climate change by suppressing air pollution and greenhouse fluid emissions.

A battery manufacturing apparatus according to embodiments of the present disclosure may include a plurality of cell processors arranged in a first direction, the plurality of cell processors each including a heating unit to heat a battery cell, and a movement adjuster adjusting a distance between the plurality of cell processors by moving the plurality of cell processors in the first direction, wherein one cell processor among the plurality of cell processors maintains a distance between the one cell processor and another cell processor adjacent to the one cell processor at a predetermined target distance by the movement adjuster, and heats the battery cell mounted on the one cell processor together with the another cell processor adjacent to the one cell processor.

The battery manufacturing apparatus may further include: a first support portion and a second support portion arranged on both sides of the plurality of cell processors in the first direction, and a pressure sensor located on one support portion of the first and second support portions and measuring pressure applied to the plurality of cell processors or the battery cell when the plurality of cell processors are moved by the movement adjuster.

The pressure sensor may be a load cell coming into contact with an outside of the plurality of cell processors when the plurality of the cell processors are moved.

The movement adjuster may include a moving shaft supported by an other support portion of the first and second support portions and rotating to move the plurality of cell processors.

The movement adjuster may further include a movement preventing portion preventing rotation of the moving shaft to suppress expansion of the battery cell.

Each of the plurality of cell processors may further include: a main body portion supporting the heating unit and pressurizing the battery cell, and a fixing portion guiding the battery cell to the heating unit and detachably fixing the battery cell to the main body portion, and the heating unit may include: a first heater provided on a front surface of the main body portion at which the fixing portion is located, and heating the battery cell, and a second heater located in a direction opposite to the front surface and heating another adjacent battery cell.

Each of the plurality of cell processors may further include a temperature sensor located at a lower part of the main body portion and sensing temperature of the heating unit.

The heating unit may heat the battery cell to a predetermined allowable temperature or less.

Each of the plurality of cell processors may further include: a wing portion extending in a second direction perpendicular to the first direction from each of both sides of the main body portion, a recessed portion formed by recessing at least a portion of a side surface of the wing portion toward the main body portion, and a gap block including an extension portion extending in the first direction from the wing portion and a bent portion bent toward the fixing portion from one end of the extension portion.

A part of the bent portion of the one cell processor may be inserted into the recessed portion of the another cell processor.

When the bent portion of the one cell processor is inserted into the recessed portion of the another cell processor, the gap block of the one cell processor may maintain the predetermined target distance with the another cell processor.

The fixing portion may include a first fixing block and a second fixing block arranged in the second direction and extending in a height direction of the main body portion, and lower ends of the first fixing block and the second fixing block may be bent toward each other.

Each of the plurality of cell processors may further include a wheel located at a lower part of the wing portion.

The battery manufacturing apparatus may further include a guide rod extending in the first direction, wherein each of the plurality of cell processors further includes a connecting hole formed through the wing portion and inserted into the guide rod.

A method of controlling a battery manufacturing apparatus including a plurality of cell processors arranged in a first direction and each including a heating unit heating a battery cell, and a movement adjuster adjusting a distance between the plurality of cell processors by moving the cell processors in the first direction according to embodiments of the present disclosure may include maintaining a distance between one cell processor among the plurality of cell processors and another cell processor adjacent to the one cell processor at a predetermined initial distance by the movement adjuster, arranging the battery cell in each of the plurality of cell processors, pressurizing the battery cell arranged in each of the plurality of cell processors to a predetermined target pressure by moving the plurality of cell processors in the first direction by the movement adjuster, and heating the battery cell by the heating unit while a distance between the one cell processor and the another cell processor is maintained at a predetermined target distance.

In the pressurizing of the battery cell at the predetermined target distance, pressure applied to the battery cell may be measured by a pressure sensor located at one end of the plurality of cell processors in the first direction.

In the heating of the battery cell by the heating unit while maintaining the predetermined target distance, the predetermined target distance may be maintained by a gap block provided in each of the plurality of cell processors and connecting between the plurality of cell processors.

In the heating of the battery cell by the heating unit while maintaining the predetermined target distance, the heating unit may heat the battery cell to a predetermined allowable temperature or less.

### BRIEF DESCRIPTION OF THE DRAWINGS

FIG. 1 shows an example of a battery manufacturing apparatus according to the present disclosure.

FIG. 2 shows an example of a battery manufacturing apparatus according to the present disclosure as viewed from the side (a Y direction).

FIG. 3 is a block diagram related to a controller.

FIG. 4 shows an example of a cell processor.

FIG. 5 shows an example of a cell processor shown in FIG. 4 as viewed from the back.

FIG. 6 schematically illustrates an example in which a plurality of cell processors pressurize a battery cell.

FIG. 7 is a flowchart illustrating an example of a method of controlling a battery manufacturing apparatus according to the present disclosure.

### DETAILED DESCRIPTION

Hereinafter, preferred embodiments of the present disclosure will be described in detail with reference to the attached drawings. The configuration or control method of the device described below is only for explaining the embodiments of the present disclosure and is not intended to limit the scope of the present disclosure, and the same reference numerals used throughout the specification indicate the same components.

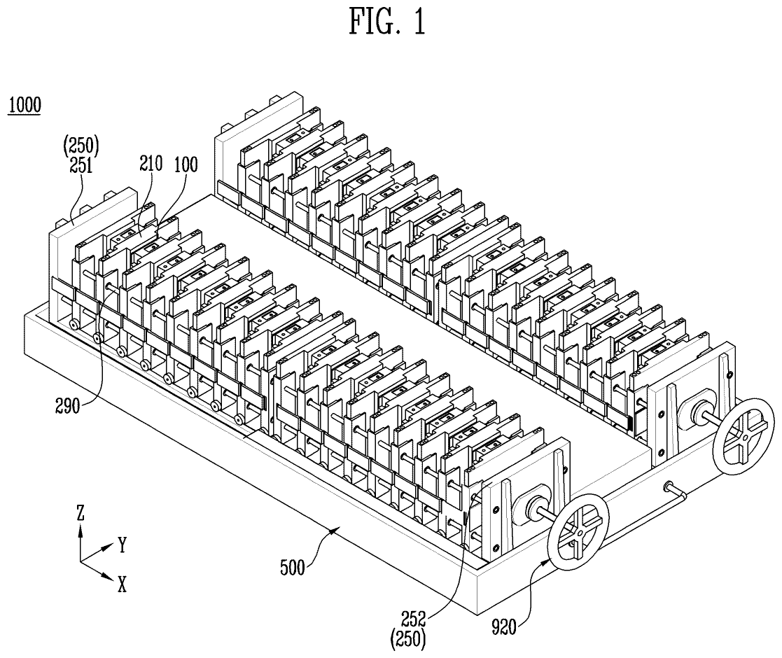

FIG. 1 shows an example of a battery manufacturing apparatus 1000 according to the present disclosure.

Referring to FIG. 1, the battery manufacturing apparatus 1000 according to the present disclosure may include a plurality of cell processors 210 which are disposed an in a first direction (X direction), and a movement adjuster 920 which adjusts a distance between the plurality of cell processors 210 by moving the plurality of cell processors 210 in the first direction.

In addition, the battery manufacturing apparatus 1000 may further include a support 500 for supporting the plurality of cell processors 210. The support 500 may further include a traveling unit (not shown) or a rail (not shown) for moving the plurality of cell processors 210 in the first direction. The plurality of cell processors 210 may be moved more smoothly through the traveling unit.

In addition, the battery manufacturing apparatus 1000 may further include a guide rod 290 which guides the movement of the plurality of cell processors 210. The guide rod 290 may extend in the first direction.

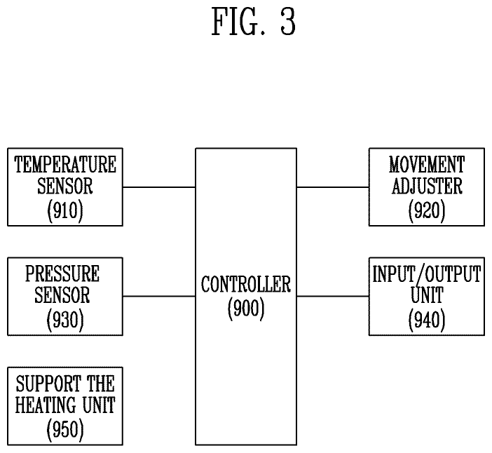

The battery cell 100 may be accommodated in one of the plurality of cell processors 210. In addition, the battery cell 100 may be heated by a heating unit 950 (see FIG. 3) to be described below. In addition, a plurality of battery cells 100 may be provided corresponding to the number of cell processors 210.

The cell processor 210 may pressurize and heat the battery cell 100 accommodated in the cell processor 210 (or the battery cell 100 in contact with the cell processor 210). The cell processor 210 may heat the battery cell 100 mounted on the one cell processors 210 together with the another cell processor 210 adjacent to the one cell processor 210. More specifically, the cell processor 210 may pressurize and heat the battery cell 100 while the distance between the plurality of cell processors 210 is maintained at a predetermined target distance.

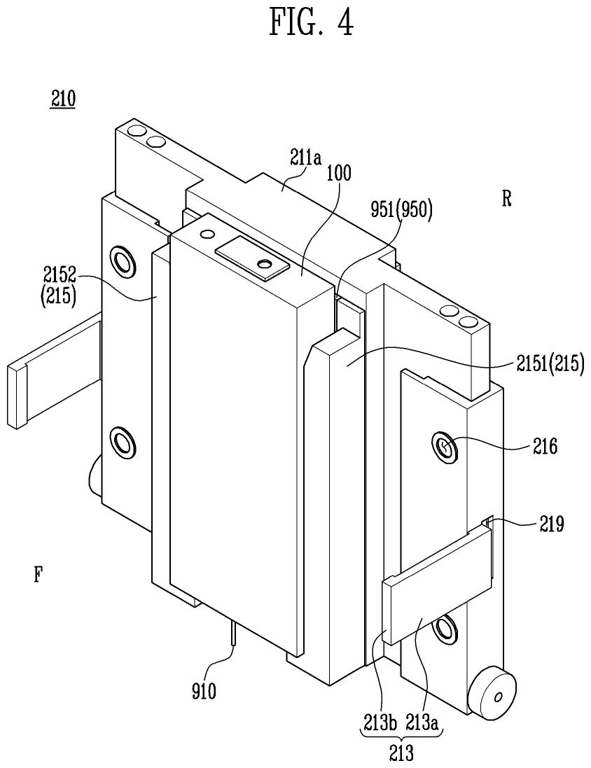

The distance between the plurality of cell processors 210 refers to a distance between one of the cell processors 210 and another cell processor 210 adjacent to thereto. More specifically, the distance refers to a distance between one of the main body portions 211a (see FIG. 4) to be described below and another main body portion 211a adjacent to thereto.

The movement adjuster 920 may individually control the plurality of cell processors 210, so that the distance between the plurality of cell processors 210 may decrease from a predetermined initial distance to a predetermined target distance, or may increase from the target distance to the initial distance.

The movement adjuster 920 may move the plurality of cell processors 210 in the first direction on the support 500. By the movement adjuster 920, the battery manufacturing apparatus 1000 may maintain the distance between the plurality of cell processors 210 at the predetermined initial distance, or may adjust the distance between the cell processors 210 to the target distance which is less than the length of the initial distance. However, the movement adjuster 920 may also adjust the distance between the plurality of cell processors 210 from the target distance to the initial distance.

Referring to FIG. 1, the movement adjuster 920 may further include a moving shaft 927 which rotates to adjust the distance between the plurality of cell processors 210. The moving shaft 927 may be in the form of a screw including a screw wire on an outer circumferential surface thereof. The moving shaft 927 may be provided in another manner as long as the plurality of cell processors 210 are moved in the first direction. For example, a component such as a linear actuator may be used instead of the moving shaft 927.

Referring to FIG. 1, the battery manufacturing apparatus 1000 may further include a support 250 arranged while interposing the plurality of cell processors in the first direction.

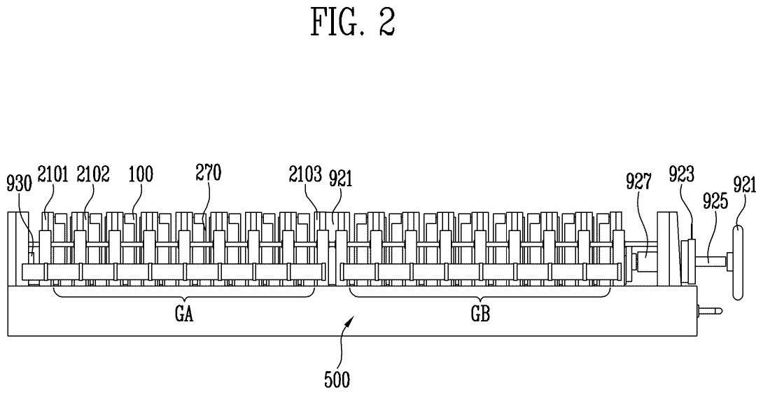

A pressure sensor 930 (see FIG. 2) may be located on the support 250 and measure pressure applied to the plurality of cell processors 210. In addition, the support 250 may support the moving shaft 927 (see FIG. 1) rotated by a driver 921.

More specifically, the support 250 may include a first support portion 251 and a second support portion 252 disposed on both sides of the plurality of cell processors 210 in the first direction.

In addition, the battery manufacturing apparatus 1000 may further include the pressure sensor 930 positioned on one of the first support portion 251 and the second support portion 252 to measure pressure applied to the plurality of cell processors 210. The pressure sensor 930 measured pressure applied to the plurality of cell processors 210 or the battery cell 100 when the plurality of cell processors 210 are moved by the movement adjuster 920. The battery manufacturing apparatus 1000 may include the moving shaft 927 which is supported by the other support and rotates to move the plurality of cell processing parts 210.

FIG. 2 shows an example of the battery manufacturing apparatus 1000 according to the present disclosure as viewed from the side (a Y direction).

Referring to FIG. 2, the pressure sensor 930 is disposed on the first support portion 251, and the moving shaft 927 is supported by the second support portion 252. However, the present disclosure is not limited thereto. However, the pressure sensor 930 may be disposed at another position as long as the pressure applied to the plurality of cell processors 210 is measured.

The pressure sensor 930 may be a load cell which comes into contact with the outside of the plurality of cell processors 210 when the plurality of cell processors 210 are moved. Since the pressure applied to the plurality of cell processors 210 corresponds to pressure applied to the battery cell 100, the pressure sensor 930 may not be in direct contact with the battery cell 100.

Alternatively, the pressure sensor 930 may be a sensor which measures the pressure applied to the plurality of cell processors 210 by using capacitance. In addition, the pressure applied to the plurality of battery cells 100 may be measured by various methods.

Referring to FIG. 2, the movement adjuster 920 may further include the driver 921 to adjust the distance between the plurality of cell processors 210 by the moving shaft 927. FIG. 2 illustrates an example in which the driver 921 is provided as a ring-shaped handle. However, the driver 921 may include one of a servomotor, a torque wrench, and an electric driver to rotate the moving shaft 927.

Referring to FIGS. 1 and 2, the plurality of cell processors 210 may be arranged in a plurality of columns instead of a single column arranged in the first direction. The battery manufacturing apparatus 1000 may pressurize and heat more battery cells 100 at a time through the plurality of columns. The pressure sensor 930 and the movement adjuster 920 may be separately provided for each of the columns. Therefore, the cell processor 210 arranged in the above-described one column may be independently controlled regardless of the cell processors 210 arranged in another column.

The movement adjuster 920 may further include a movement preventing portion 923 to prevent the rotation of the moving shaft 927 and to fix the distance between the plurality of cell processors 210.

The movement preventing portion 923 may prevent the plurality of cell processors 210 from moving when the plurality of battery cells 100 are heated and expanded.

Referring to FIG. 2, the movement preventing portion 923 is provided as a pin-shaped lever and prevents the handle-shaped driver 921 from rotating in a direction in which the pressurization is released by rotation.

That is, the movement preventing portion 923 may serve as a fixing mechanism which prevents rotation of the rotating shaft.

The movement preventing portion 923 may fix a connecting shaft 925 connecting the moving shaft 927 and the driver 921 to block the transmission of a repulsive force from the moving shaft 926 to the driver 921, or a driving force transmitted from the driver 921 to the moving shaft 927.

For example, the movement preventing portion 923 is provided in the form, for example, a pin, and may be inserted in a radial direction of the movement shaft 927 to prevent the rotation of the movement shaft 827.

Referring to FIG. 2, the plurality of cell processors 210 may be arranged in the first direction and grouped into two groups GA and GB. In the case where the plurality of cell processors 210 are arranged in one row in the first direction (hereinafter, referred to as series arrangement), the length of the plurality of cell processors 210 is increased. As a result, each battery cell 100 may not be uniformly pressurized.

Therefore, in order to uniformly pressurize the battery cells 100 accommodated in the plurality of cell processors 210 under the serial arrangement, the battery manufacturing apparatus 1000 may group the plurality of cell processors 210 to prevent more than a predetermined number of cell processors 210 from simultaneously pressurizing the battery cells 100.

That is, the battery cells 100 accommodated in the cell processor 210 included in one group may be disposed in a direction toward another group.

Further, the directions of the battery cells 100 accommodated in the cell processor 210 included in each group may be opposite to each other. However, this is only an example, and the battery cells 100 may be arranged in the same direction.

In addition, referring to FIGS. 1 and 2, since two groups of the cell processors 210 are included in one column, an example of the battery manufacturing apparatus 1000 is shown as including four groups of the cell processors 210 in two columns in total. However, the battery manufacturing apparatus 1000 according to the present disclosure is not limited thereto.

Each group of the cell processors 210 may include the cell processors 210 which are grouped into the predetermined number.

The group of the cell processors 210 may include a first cell processor 2101 and a third cell processor 2103, which are located on the outermost edge of the group of the cell processors 210 in the first direction, and one or more second cell processors 2102, which are located between the first cell processor 2101 and the third cell processor 2103.

Since the first cell processor 2101 heats only the battery cell 100 detachably fixed to the first cell processor 2101, the heating unit 950 (see FIG. 4) to be described below may be included only on one of both surfaces of the first cell processor 2101. On the other hand, since the third cell processor 2103 heats only another battery cell 100 adjacent to the third cell processor 2103, the third cell processing section 2103 may include only the heating unit 950 on one surface thereof without a fixing portion 215 for accommodating the battery cells 100.

The second cell processor 2102 may include the heaters 950 on both sides thereof to heat not only the battery cell 100 accommodated in the second cell processor 2102 but also adjacent another battery cell 100.

FIG. 3 is a block diagram related to a controller 900.

The battery manufacturing apparatus 1000 according to the present disclosure may include the controller 900 which controls the movement adjuster 920. The battery manufacturing apparatus 1000 may sense the load or pressure applied to the battery cell 100 by the pressure sensor 930.

In addition, the controller 900 may control the heating unit 950 which heats the battery cell 100, and may detect temperature at which the battery cell 100 is heated by the temperature sensor 910.

In addition, the battery manufacturing apparatus 1000 may include an input/output unit 940 which receives a user's command and outputs information about the battery cell 100 to the user. The input/output unit 940 may be located on the support 500.

The controller 900 may receive and perform a user's command by the input/output unit 940 and display the pressure applied to the battery cell 100 by the pressure sensor 930 and the temperature of the battery cell 100 by the temperature sensor 910 to the user.

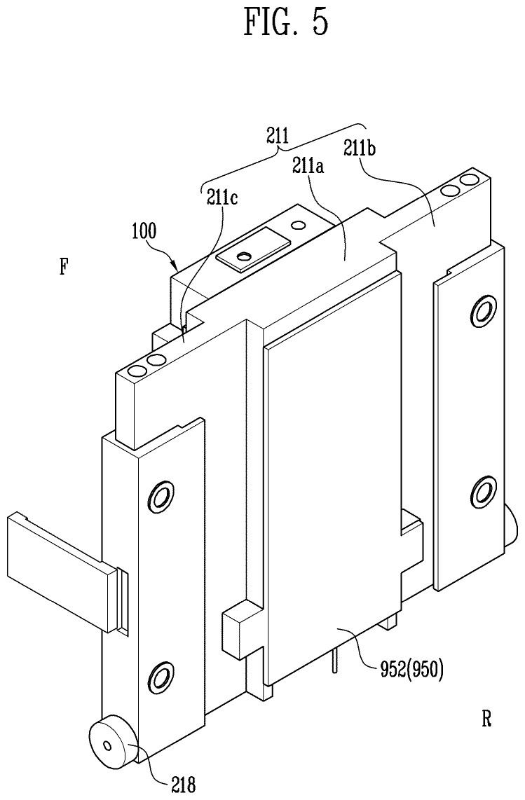

FIG. 4 shows an example of the cell processor 210. FIG. 5 shows an example of the cell processor 210 shown in FIG. 4 as viewed from the back.

Referring to FIG. 4, the cell processor 210 may receive and heat the battery cell 100. Preferably, one cell processor 210 may accommodate one battery cell 100. More specifically, after the battery cell 100 is detachably fixed, the battery cell 100 may come into contact with one surface of the battery cell 100 and be heated.

In addition, the cell processor 210 may be in contact with one surface of another battery cell 100 adjacent to the cell processor 220 to heat the surface of the battery cell 100. When the battery cell 100 is heated, a distance between the cell processor 210 and the cell processor 210 accommodating the adjacent battery cell 100 may be a predetermined target distance.

As described above, a target distance GL may be maintained by the movement adjuster 920.

The cell processor 210 may include the heating unit 950 to heat the battery cell 100, a main body portion 211a to support the heating unit 950 and pressurize the battery cell 100 and a fixing portion 215 to guide the battery cell 100 to the heater 950 and detachably fix the battery cell 100 to the main body portion 211a.

Referring to FIG. 4, the main body portion 211a may be provided in a planar shape, and the heating unit 950 may be attached to one surface of the main body portion 211a. The heating unit 950 may be a pad type heater.

For example, the heating unit 950 may be formed by wiring a heating wire between pads and performing a press process. The pad may include a material such as silicone or epoxy rubber. Therefore, the heating unit 950 may prevent damage to the battery cell 100 even when the heating unit 950 comes into contact with one surface of the battery cell 100.

In addition, the main body portion 211a may include a material having a small deformation during pressurization in order to pressurize the battery cell 100. For example, the material of the main body portion 211a may be aluminum.

One surface of the battery cell 100 in contact with the heating unit 950 may be one surface having the largest area among the surfaces forming the outer shape of the battery cell 10.

For example, one surface having the largest area may face an anode, a cathode, and a protective film in a direction in which the anode, the cathode, and the protective film accommodated in the battery cell 100 are stacked.

The heating unit 950 may include a first heater 951 coupled to a front surface of the main body portion 211a (or a surface on which the fixing portion 215 protrudes or a surface located in an F direction), and a second heater 952 coupled to a rear surface of the main body portion 211a (or the surface located in the R direction) (see FIG. 5).

The first heater 951 may heat the battery cell 100 accommodated in the cell processor 210 provided with the first heater 951 (or the battery cell 100 accommodated in the front surface of the main body portion 211a), and the second heater 952 may heat another battery cell 100 adjacent to the rear surface of the main body portion 211a and the cell processor 110.

The fixing portion 215 may be coupled to the front surface of the main body portion 211a. The fixing portion 215 may be located on both sides of the first heater 951 from the front surface of the main body portion 211a. The battery cell 100 in contact with the first heater 951 may be stably supported by the fixing portion 215.

In addition, the fixing portion 215 may include a material which is resistant to deformation by heat since because the fixing portion 215 is adjacent to the heating unit 950. Therefore, the fixing portion 215 may include a polymer material which is excellent in heat resistance and mechanical strength, and may reduce deformation or damage of the case of the battery cell 100 when the fixing portion 215 is in contact with the battery cell 100. For example, the polymer material may be polyetheretherketone (PEEK).

The fixing portion 215 may guide the battery cell 100 and detachably fix both sides of the battery cell 100 so that the battery cell 100 may come into contact with the first heater 951.

To this end, an upper region of the surface of the fixing portion 215 which comes into contact with the battery cell 100 may be provided to be inclined. Accordingly, when the battery cell 100 is inserted, the fixing portion 215 may naturally guide the battery cell 100 to move toward the heating unit 950.

The fixing portion 215 may include a first fixing block 2151 and a second fixing block 2152 disposed in a second direction perpendicular to the first direction and extending in a height direction of the main body portion.

The first fixing block 2151 and the second fixing block 2152 may be provided on both sides of the heating unit 950 or the first heater 951 to detachably fix the battery cell 100.

In addition, the first fixing block 2151 and the second fixing block 2152 may serve as stoppers for restricting movements of the battery cell 100 in order to prevent the battery cell 100 from coming into contact with the support 500. To this end, the lower ends of the first fixing block 2151 and the second fixing block 2152 may be bent toward each other.

Referring to FIG. 5, the main body portion 211a may further include wing portions 211b and 211c extending in the second direction on both sides of the main body portion 211a. The main body portion 211a and the wing portions 211b and 211c may be referred to as a pressurizing plate 211.

In the first direction, the thickness of the main body portion 211a may be greater than the thickness of the wing portions 211b and 211c. The battery cell 100 is pressurized by the main body portion 211a. In addition, since the wing portions 211b and 211c are provided on both sides of the main body portion 211a in the second direction, an external force applied to the blade portions 212b and 211b may be dispersed unlike the main body portion 211a.

The cell processor 210 may further include a recessed portion 219 formed by recessing at least a part of each of the side surfaces of the wing portions 211b and 211c toward the main body portion 211a.

In addition, the cell processor 210 may further include gap blocks 213 located in the wing portions 211b and 211c to maintain the distance between the main body portion 211a and another main body portion 211a adjacent to the main body portion 210a at the target distance.

Since the wing portions 211b and 211c are respectively located on both sides of the main body portion 211a, the gap blocks 213 may also be respectively located on both sides of the main body portion 211a.

The gap block 213 may include an extension portion 213a which extends in the first direction from the wing portions 211b and 211c toward the front of the main body portion 211a, and a bent portion 213b which is bent from one end of the extension portion 213a toward the fixing portion 215.

As described above, the movement preventing portion 923 (see FIG. 2) may prevent the pressurization of the battery cell 100 by the cell processor 210 from being released due to the rotation of the moving shaft 927 caused by the expansion of the battery cell 110. On the other hand, the gap block 213 may maintain the target distance to prevent the cell processor 210 from further decreasing below the target distance.

More specifically, when the bent portion 213b of one of the cell processors 210 is inserted into the recessed portion 219 of another cell processor 210 adjacent to the cell processor 210, the distance between the cell processor 220 and another cell processor 210 will be maintained at the target distance.

At the target distance, the bent portion 213b of one of the cell processors 210 may be inserted into the recessed portion 219 of another cell processor 210 adjacent to the one cell processed portion 210. As a result, the distance between the one cell processor 210 and another cell processor 210 may be maintained at the target distance.

More specifically, the distance between one of the main body portions 211a and another main body portion 211a adjacent to the one main body portion 211a may be maintained at the target distance.

In addition, even when the battery cell is expanded by the heating unit 950, the gap block 213 may maintain the target distance. That is, even when the pressure applied to the battery cell 100 or the cell processor 210 increases due to the expansion of the battery cell 100 at the target distance, the distance between the plurality of cell processors 210 may be maintained at the target distance.

Referring to FIGS. 4 and 5, the battery cell 100 may further include a temperature sensor 910 positioned at the lower part of the main body portion 211a to sense the temperature of the heating unit 950 or the temperature of the battery cell 100. Since the temperature sensor 910 is located at the lower part of the main body portion 211a, the temperature sensor 910 senses the temperature of the main body portion 211a. However, since the main body portion 210a, the heating unit 950, and the battery cell 100 in contact with the heating unit 950 are in thermal equilibrium, the temperature sensor 910 may sense the temperature of the battery cell 100.

Referring to FIGS. 4 and 5, the cell processor 210 may further include wheels 218 for facilitating the movements of the cell processor 310 when the cell processor 210 moves in the first direction on the support 500.

The wheels 218 are located at the lower parts of the wing portions 211b and 211c and rotate when the cell processor 210 moves to assist the movements of the cell processor 310.

Referring to FIGS. 4 and 5, the wing portions 211b and 211c may further include a connecting hole 216 passing through the wing portions 211b and 211c in the first direction. Since the guide rod 290 (see FIG. 1) is inserted into the connection hole 216, when the cell processor 210 moves in the first direction, shaking of the cell processor 310 in a direction other than the first direction may be reduced and the position of the cell processors 210 may be precisely controlled.

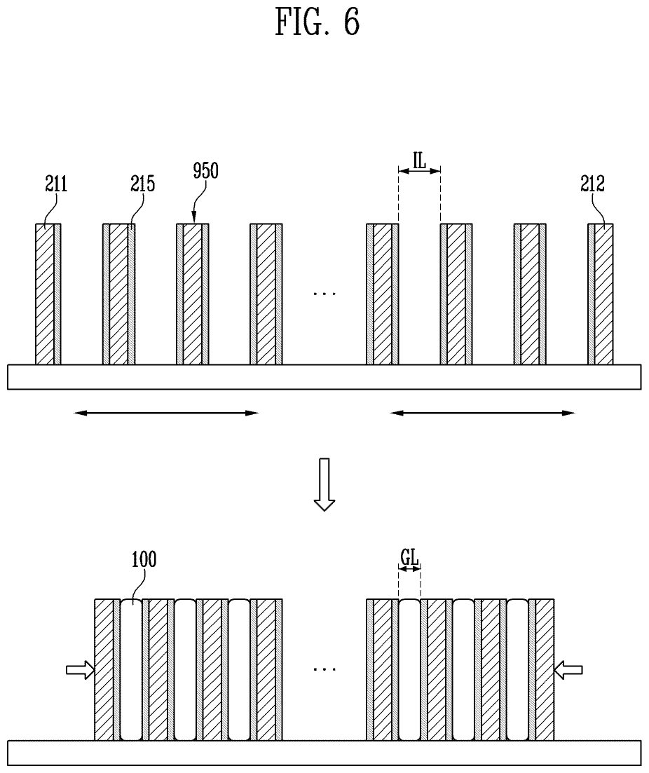

FIG. 6 schematically illustrates an example in which the plurality of cell processors 210 pressurize the battery cells 100.

Referring to FIG. 6, the controller 900 may adjust the distance between the plurality of cell processors 210 to an initial distance IL (referring to the upper drawing in FIG. 6) by the movement adjuster 920. At the initial distance IL, the battery cell 100 may be disposed in each of the plurality of cell processors 210.

The initial distance IL may be greater than the thickness of the battery cell 100. That is, the initial distance IL may refer to a state in which the plurality of cell processors 210 are opened to accommodate the battery cell 100.

When the arrangement of the battery cells 100 is completed, the controller 900 may adjust the distance between the plurality of cell processors 210 by the movement adjuster 920 to pressurize the battery cell 100 at a predetermined target pressure.

The distance between the plurality of cell processors 210 at the target pressure may be the target distance GL (referring to the lower drawing in FIG. 6).

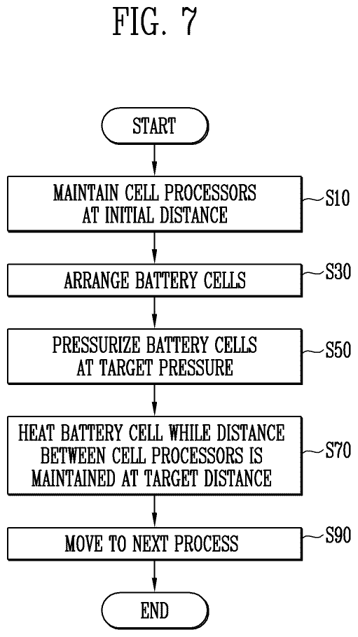

FIG. 7 is a flowchart illustrating an example of a method of controlling a battery manufacturing apparatus according to the present disclosure.

Referring to FIG. 7, a method of controlling a battery manufacturing apparatus according to the present disclosure may include maintaining a distance between one of the plurality of cell processors 210 and another cell processor 210 adjacent to the one cell processor 210 at the predetermined initial distance IL by the movement adjuster 920 at step S10, arranging each of the battery cells 100 in each of the plurality of the cell processors 210 at step S30, moving the plurality of the cell processors 210 in the first direction by the movement adjuster 920 to pressurize each of the battery cells 100 arranged in each of the plural cell processors 210 to a predetermined target pressure at step S50, and heating the battery cells 100 by the heating unit 950 while maintaining a distance between the one cell processor 210 and another cell processor 210 at a predetermined target distance at step S70.

Subsequently, the control method according to the present disclosure may include moving the heated battery cell 100 to the next process for a predetermined heating time at step S90. The next process may be a charging process of charging the battery cell 100.

For example, the next process may be a pre-charge process. That is, the battery manufacturing apparatus 1000 may be used to heat the battery cell 100 prior to the pre-charge process of the battery cell 100. That is, by heating the battery cell 100, the impregnation property of the electrolyte solution may be improved, and the battery cell 100 may be pre-charged smoothly. Alternatively, the battery manufacturing apparatus 1000 may also be used during the pre-charge process.

More specifically, the battery manufacturing apparatus 1000 may be used in conjunction with a device for hot vacuum charge (HVC). Alternatively, the battery manufacturing apparatus 1000 may be used in conjunction with a device for hot vacuum press charge (HVPC).

For example, according to the control method according to the present disclosure, the battery cell 100 may be pressurized to the target distance GL by the cell processor 210 and may be heated before or during the pre-charge process. Subsequently, the battery manufacturing apparatus 1000 may be moved to the device for the hot vacuum press charge (HVPC) while the target distance GL is maintained.

Subsequently, the battery cell 100 may be charged while the target distance GL is maintained in the device for the hot vacuum press charge (HVPC). After the charging is completed, the pressurization of the battery cell 100 may be released.

At step S30 of arranging each of the battery cells 100 in each of the plurality of cell processors 210, the method of controlling the battery manufacturing apparatus according to the present disclosure may include arranging the battery cells 100 between the plurality of cell processors 210. The battery cells 100 may be arranged by a device such as a gripper.

More specifically, the battery cell 100 may be guided by the fixing portion 215 to contact the heating unit 950 (or the first heater 951).

Subsequently, according to the method of controlling the battery manufacturing apparatus according to the present disclosure, each of the battery cells 100 disposed in each of the plurality of cell processors 210 may be pressurized to a predetermined target pressure by moving the plurality of cell processors 210 in the first direction by the movement adjuster 920 at step S50.

At step S50 of pressurizing the battery cells 100 to the target pressure, the plurality of cell processors 210 may pressurize the battery cells 100 accommodated in the cell processors 210, respectively, by the movement adjuster 920 until the pressure sensed by the pressure sensor 930 reaches the predetermined target pressure.

For example, the load applied to the battery cell 100 at the target distance GL may be 5 tons or less. The target pressure may vary depending on the area of one side of the battery cell 100 applied to the load. In addition, the pressure sensor 930 may sense the load applied to the battery cell 100 instead of the pressure applied to the battery cells 100.

When the target distance GL is reached, the controller 900 may limit the rotation of the moving shaft 927 by the movement preventing portion 923 so that the distance between the plurality of battery cells may not be changed.

Subsequently, according to the control method according to the present disclosure, the heating unit 950 may heat the battery cell 100 while the predetermined target distance between one of the cell processors 210 and another cell processor 210 is maintained at step S70.

The target distance may be maintained by inserting a portion (or specifically, the bent portion 213b) of the gap block 213 of one of the cell processors 210 into the recessed portion 219 of another cell processor 210. When the portion of the gap block 213 of one of the cell processors 210 is inserted into the recessed portion 219 of another cell processor 210, the distance between the cell processor 210 and another cell processor 210 may be maintained at the target distance GL.

The heating unit 950 may heat the battery cell 100 to a predetermined allowable temperature or less.

Since the heating unit 950 heats the battery cell 100 through one surface having the largest area among the surfaces of the battery cell 100, it may take a relatively smaller amount of time as compared to when the bottom surface of the battery cell 100 is heated.

In addition, since the heating unit 950 is provided in the form of a pad having an area similar to the largest area of one surface of the battery cell 100, the battery cell 100 may be heated more uniformly.

For example, the allowable temperature may be less than or equal to 90° C. (Celsius), whereby the electrolyte contained in the battery cell 100 may be prevented from boiling.

Even when the battery cell 100 is heated and expanded by the heating unit 950 to increase the pressure applied to the battery cell 100, the target distance GL may remain unchanged by the gap block 213 and the movement preventing portion 923. Therefore, even when the battery cell 100 is heated, deformation such as expansion or distortion of the case of the battery cell 100 due to heating may be prevented.

According to an embodiment of the present disclosure, a heating area of a battery cell may be increased, and the increased heated area may be uniformly heated.

According to another embodiment of the present disclosure, the time required to heat the battery cell may be shortened.

According to another embodiment of the present disclosure, deformation of a case may be reduced when the battery cell is heated.

According to another embodiment of the present disclosure, the impregnation of an electrolyte may be improved and pre-charge may be facilitated.

According to another embodiment of the present disclosure, the efficiency of manufacturing processes of the battery cell may be improved.

The present disclosure may be modified and implemented in various forms, and its scope is not limited to the above-described embodiments. The content described above is merely an example of applying the principles of the present disclosure, and other features may be further included without departing from the scope of embodiments according to the present disclosure.

What is claimed is:

1. A battery manufacturing apparatus comprising:
a plurality of cell processors arranged in a first direction, the plurality of cell processors each including a heating unit to heat a battery cell; and
a movement adjuster adjusting a distance between the plurality of cell processors by moving the plurality of cell processors in the first direction,
wherein one cell processor among the plurality of cell processors maintains a distance between the one cell processor and another cell processor adjacent to the one cell processor at a predetermined target distance by the movement adjuster, and heats the battery cell mounted on the one cell processor together with the another cell processor adjacent to the one cell processor.

2. The battery manufacturing apparatus according to claim 1, further comprising:
a first support portion and a second support portion arranged on both sides of the plurality of cell processors in the first direction; and
a pressure sensor located on one support portion of the first and second support portions and measuring pressure applied to the plurality of cell processors or the battery cell when the plurality of cell processors are moved by the movement adjuster.

3. The battery manufacturing apparatus according to claim 2, wherein the pressure sensor is a load cell coming into contact with an outside of the plurality of cell processors when the plurality of the cell processors are moved.

4. The battery manufacturing apparatus according to claim 2, wherein the movement adjuster comprises a moving shaft supported by an other support portion of the first and second support portions and rotating to move the plurality of cell processors.

5. The battery manufacturing apparatus according to claim 4, wherein the movement adjuster further comprises a movement preventing portion preventing rotation of the moving shaft to suppress expansion of the battery cell.

6. The battery manufacturing apparatus according to claim 1, wherein each of the plurality of cell processors further comprises:
a main body portion supporting the heating unit and pressurizing the battery cell; and
a fixing portion guiding the battery cell to the heating unit and detachably fixing the battery cell to the main body portion, and
wherein the heating unit comprises:
a first heater provided on a front surface of the main body portion at which the fixing portion is located, and heating the battery cell; and
a second heater located in a direction opposite to the front surface and heating another adjacent battery cell.

7. The battery manufacturing apparatus according to claim 6, wherein each of the plurality of cell processors further comprises a temperature sensor located at a lower part of the main body portion and sensing temperature of the heating unit.

8. The battery manufacturing apparatus according to claim 7, wherein the heating unit heats the battery cell to a predetermined allowable temperature or less.

9. The battery manufacturing apparatus according to claim 6, wherein each of the plurality of cell processors further comprises:
a wing portion extending in a second direction perpendicular to the first direction from each of both sides of the main body portion;
a recessed portion formed by recessing at least a portion of a side surface of the wing portion toward the main body portion; and
a gap block including an extension portion extending in the first direction from the wing portion and a bent portion bent toward the fixing portion from one end of the extension portion.

10. The battery manufacturing apparatus according to claim 9, wherein a part of the bent portion of the one cell processor is inserted into the recessed portion of the another cell processor.

11. The battery manufacturing apparatus according to claim 9, wherein when the bent portion of the one cell processor is inserted into the recessed portion of the another cell processor, the gap block of the one cell processor maintains the predetermined target distance with the another cell processor.

12. The battery manufacturing apparatus according to claim 9, wherein the fixing portion includes a first fixing block and a second fixing block arranged in the second direction and extending in a height direction of the main body portion, and
wherein lower ends of the first fixing block and the second fixing block are bent toward each other.

13. The battery manufacturing apparatus according to claim 9, wherein each of the plurality of cell processors further comprises a wheel located at a lower part of the wing portion.

14. The battery manufacturing apparatus according to claim 9, further comprising a guide rod extending in the first direction,
wherein each of the plurality of cell processors further comprises a connecting hole formed through the wing portion and inserted into the guide rod.

15. A method of controlling a battery manufacturing apparatus including a plurality of cell processors arranged in a first direction and each including a heating unit heating a battery cell, and a movement adjuster adjusting a distance between the plurality of cell processors by moving the cell processors in the first direction, the method comprising:
maintaining a distance between one cell processor among the plurality of cell processors and another cell processor adjacent to the one cell processor at a predetermined initial distance by the movement adjuster;
arranging the battery cell in each of the plurality of cell processors;
pressurizing the battery cell arranged in each of the plurality of cell processors to a predetermined target pressure by moving the plurality of cell processors in the first direction by the movement adjuster; and
heating the battery cell by the heating unit while a distance between the one cell processor and the another cell processor is maintained at a predetermined target distance.

16. The method according to claim 15, wherein in the pressurizing of the battery cell at the predetermined target distance, pressure applied to the battery cell is measured by a pressure sensor located at one end of the plurality of cell processors in the first direction.

17. The method according to claim 15, wherein in the heating of the battery cell by the heating unit while maintaining the predetermined target distance, the predetermined target distance is maintained by a gap block provided in each of the plurality of cell processors and connecting between the plurality of cell processors.

18. The method according to claim 15, wherein in the heating of the battery cell by the heating unit while maintaining the predetermined target distance, the heating unit heats the battery cell to a predetermined allowable temperature or less.
